(19) United States
(12) Patent Application Publication
(10) Pub. No.: US 2010/0220467 A1
(43) Pub. Date: Sep. 2, 2010

(54) WIND AND SOLAR-POWERED LIGHT APPARATUS

(76) Inventors: Paul D. Daidone, Lindenhurst, NY (US); Lauren E. Ascani, Mahopac, NY (US)

Correspondence Address: MCGUIREWOODS, LLP, 1750 TYSONS BLVD, SUITE 1800, MCLEAN, VA, 22102, US

(21) Appl. No.: 12/764,630

(22) Filed: Apr. 21, 2010

Related U.S. Application Data
(63) Continuation-in-part of application No. 29/353,640, filed on Jan. 12, 2010.
Application No. 29/353,640 is a continuation of application No. 29/332,955, filed on Feb. 27, 2009, now Pat. No. D610732.

(51) Int. Cl. F21L 4/00; F21L 13/00

(52) U.S. Cl. 362/183; 362/192

(57) ABSTRACT

An apparatus for providing power to an illumination device includes power produced by a wind turbine and a solar array. The wind turbine may be a vertically oriented curved turbine and the solar array may be a single or a plurality of solar panels. The illumination device, wind turbine and solar array may be employed as a cost efficient substitute for commercially powered street lights and related devices, without any need for trenching commercial power lines or paying for commercial power.

### CROSS-REFERENCE TO RELATED APPLICATIONS

This is a continuation-in-part application of co-pending U.S. application Ser. No. 29/353,640, filed Jan. 12, 2010 and entitled WIND AND SOLAR-POWERED LIGHT POST, which is a continuation application of U.S. application Ser. No. 29/332,955, filed Feb. 27, 2009 and entitled WIND AND SOLAR-POWERED LIGHT POST, the disclosures of both applications are herein incorporated by reference in their entirety.

### BACKGROUND

1.0 Field of the Invention

The invention relates generally to an apparatus and associated method for generating and producing light and, more specifically, to an apparatus and associated method for providing combined wind powered and solar powered lighting for general lighting needs.

2.0 Related Art

Traditional public and private lighting systems commonly utilize commercial power to supply energy for illuminating streets, property, and the like. Providing such traditional lighting such as found in street lights or security lights, for example, can amount to sizeable costs over time, including substantial initial acquisition and installation costs of the equipment, and also ongoing costs to pay for powering such traditional lighting. As an example; typical costs for installing one non-renewable light structure such as a traditional street light may vary between about $6,000 to about $20,000; including about $2500 to about $2,200 for the pole itself and about $250 to about $1,000 for the conduit and wiring installation.

Moreover, such traditional lighting systems are also subject to commercial power outages. Commercial power outages often create a situation where an affected geographical area is left completely in the dark. It is not uncommon for a street, town or city to be left completely in the dark due to loss of commercial power.

Accordingly, there is a need for an improved lighting apparatus and method that avoids one or more of the above drawbacks and limitations of conventional public and private lighting systems.

### SUMMARY OF THE INVENTION

The apparatus and method of the invention provides a remedy for several impairments of traditional lighting systems and provides for lower cost illumination powered by using solar energy and wind energy. The remedy provided by the apparatus and method of the invention requires no commercial power, nor does it require trenching for commercial power. Moreover, the remedy may avoid ongoing commercial power bills.

In one aspect, an apparatus for producing and utilizing power for illumination includes a wind turbine configured to be mountable to a first support structure, a second support structure configured to be connected to the first support structure, a solar array configured to be connected to the second support structure and an illumination device mounted to the second support structure and powered by the wind turbine and the solar array.

In another aspect, an apparatus for producing and utilizing power for illumination includes a vertical support structure, a wind turbine mounted to one end of the vertical support structure and configured to produce electrical power from wind energy, a second support structure connected to the vertical support structure, the second support structure curving away from the vertical support structure, a solar panel mounted to the second support structure and configured to provide electrical power and an illumination device mounted to the second support structure and powered by the solar panel and the wind turbine, wherein the wind turbine is configured to rotate about a vertical axis, and wherein the vertical support structure has a longitudinal axis that is substantially parallel with the vertical axis, and wherein the solar panel and wind turbine have a common height above ground.

In still another aspect, a method for producing and utilizing power for electrical devices includes providing a wind turbine having blades oriented in a curved fashion about a vertical axis, the wind turbine configured to produce electrical power from wind energy, providing a solar array to produce electrical power from sunlight and providing a light emitting diode (LED) illumination device configured to be powered by the electrical power from the wind energy and electrical power from the sunlight, and mounting the wind turbine and solar array to different portions of a common support structure, and mounting the LED illumination device to one of the different portions, wherein the wind turbine and solar array have a common height above ground.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1A is a bottom perspective view of an embodiment of a combined wind and solar powered light apparatus, constructed according to principles of the invention;

FIG. 1B is a bottom perspective view of the apparatus of FIG. 1A, and showing additional aspects;

FIG. 2 is a side elevation view of the apparatus of FIG. 1A;

FIG. 3 is an opposite side elevation view of the apparatus of FIG. 1A;

FIG. 4 is a front elevation view of the apparatus of FIG. 1A;

FIG. 5 is a rear elevation view of the apparatus of FIG. 1A;

FIG. 6 is a top plan view of the apparatus of FIG. 1A;

FIG. 7 is a bottom plan view of the apparatus of FIG. 1A;

FIG. 8 is bottom perspective view of an embodiment of a combined wind and solar powered light apparatus, constructed according to principles of the invention;

FIG. 9 is bottom perspective view of an embodiment of a combined wind and solar powered light apparatus, with a single solar panel, constructed according to principles of the invention; and

FIG. 10 is a perspective view of an embodiment of a horizontal support structure, constructed according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

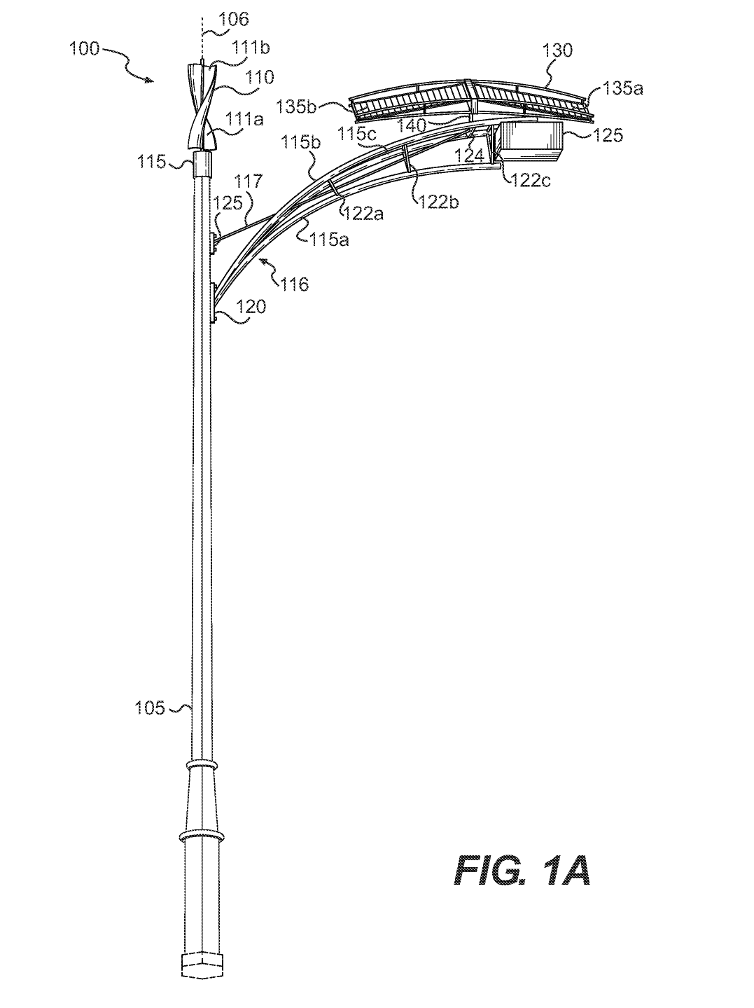

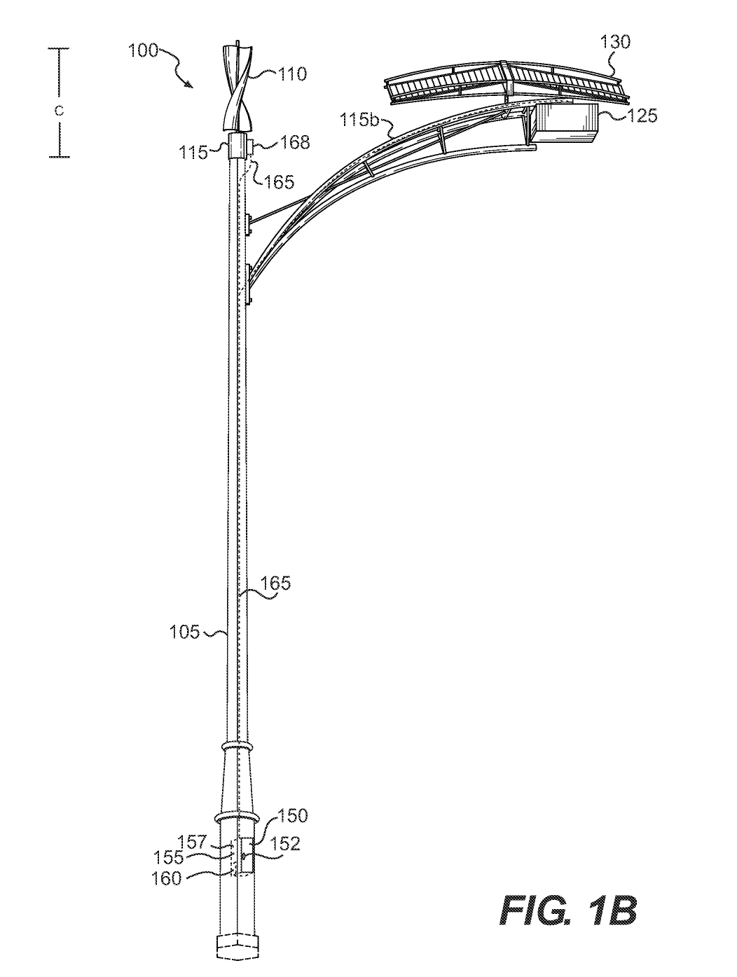

FIG. 1A is a bottom perspective view of an embodiment of a combined wind and solar powered light apparatus, generally denoted by reference numeral 100, and constructed according to principles of the invention. The combined wind and solar powered light apparatus 100 may include a vertical support structure 105 such as a street light support post, a horizontal support structure 116 configured to be connectable to the vertical support structure 105 by way of a securable mounting mechanism 120. The mounting mechanism 120 may be secured to the vertical support structure 105 by retainers, screws or bolts, for example. The horizontal support structure 116 may be configured to include one or more curved support arms 115a, 115b, 115c. The curved support arms 115a, 115b, 115c may be interconnected by bracing members 122a, 122b, 122c. The bracing members 122a, 122b, 122c may comprise multiple sections to form a triangular shape between the curved support arms 115a, 115b, 115c, thereby providing mutual support, perhaps best seen in reference to FIG. 7. A separate second support arm 117 may be utilized to provide additional support to the solar array 130, at cross brace 124, as necessary. The second support arm 117 may be mountable to the vertical support structure 105 via a second mounting mechanism 126, which may be similar to mounting mechanism 120, and may assist in supporting the solar array 130 and/or an illumination device 125.

The combined wind and solar powered light apparatus 100 may further include a wind turbine 110 that may be configured with curved vertical blades 111a, 111b. The curved vertically oriented blades 111a, 111b may be configured to spiral and/or curve around a vertical axis 106. There may be only one pair of blades, vanes, or the like. The vertical support structure 105 may have a longitudinal axis that is substantially parallel with the vertical axis 106. The set of blades 111a, 111b may be configured to be substantially mirrored images of one another. In the presence of wind, the wind blades 111a, 111b may propel a generator portion 115 of the wind turbine 110 thereby producing electrical power output. The generator portion 115 may be configured to be mountable to a top end of the vertical support structure 105. Wiring for the generator portion 115 may be connected at wiring port 168 (shown in FIG. 1B), for example.

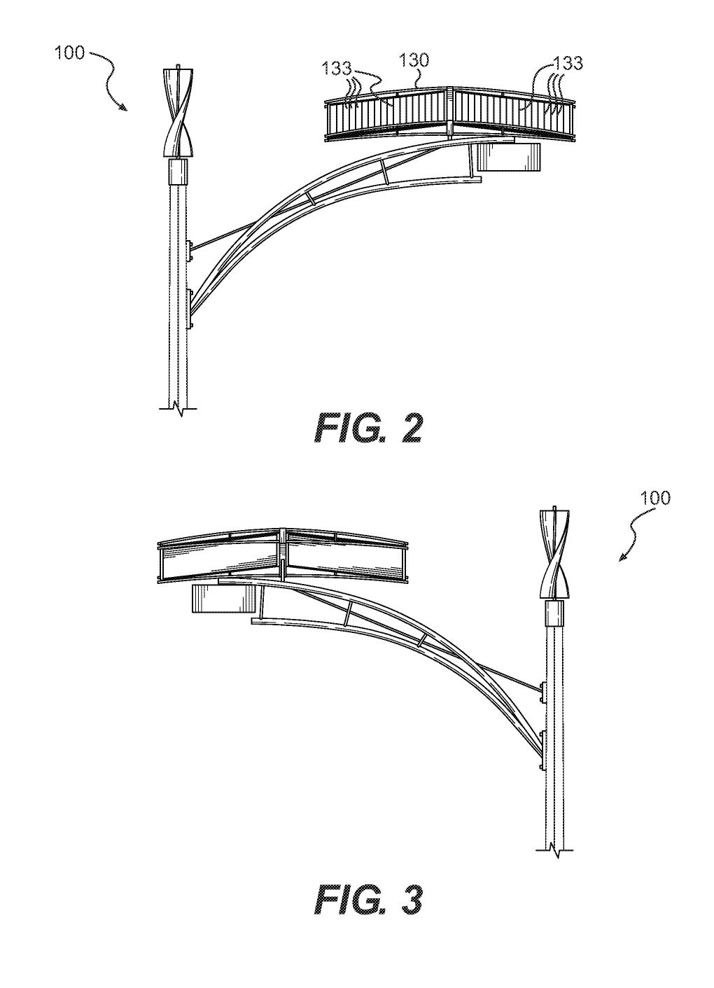

A solar array 130 may be constructed as at least one panel or a plurality of panels 135a, 135b. Each panel 135a, 135b may be oriented at an angle from its mutually connecting center for improved directionality to the sun throughout a day. Each solar panel 135a, 135b may be constructed to include a plurality of solar cells 133 (shown in FIG. 2). Other configurations of the solar array 130 may be possible, such as, e.g., one panel, or three or more panels. The solar array 130 may be configured to be mounted to the horizontal support structure 116 by attaching member 140. The cross brace 124 may be configured between curved support arms 115b, 115c and configured to provide a mounting location for the attaching member 140 for supporting the solar array 130, but other attaching configurations may be utilized, as appropriate.

An illumination device 125 may be configured to be mounted to the horizontal support structure 116, perhaps attaching to each of the support arms 115a, 115b, 115c, or a subset thereof. Each of the subset of the plurality of arms may have a first end and a second end, the first end proximate the vertical support structure, the second end proximate the illumination device, and the second end being at a common height C (FIG. 1B) as the wind turbine above ground, when installed. The subset may have a curved horizontal extent in reference to the vertical support structure, either partially or substantially the entire extent.

The illumination device 125 may be a light emitting diode (LED) array, for example, that provides substantial visible light output with a relatively low level of power consumption, as compared to conventional lighting. The illumination device 125 may be configured to project or direct light output in specific directions.

FIG. 1B is a bottom perspective view of the apparatus of FIG. 1A, but showing additional aspects including a securable compartment 155 located in the vertical support structure 105 for easy access at ground level by maintenance personnel. The securable compartment 155 may be configured in a separate base, such as may be used with a steel vertical support structure. The compartment 155 may be constructed with a door 150 lockable by a locking mechanism 152. The compartment 155 may include at least one power storage device 160 such as at least one battery that may be charged by the wind turbine 110 and/or solar array 130, and may provide power to the illumination device 125, as well as additional accessories (not shown) that may be affixed to the combined wind and solar powered light apparatus 100 and powered by the power storage device 160, including, e.g., an illuminated sign, a traffic light, a wireless communication device (e.g., an access point, an radio frequency (RF) relay, or the like), a power outlet, or the like. The compartment 155 may also include electronics 157 to regulate the charging and discharging of the battery. The electronics 157 may include a controller and at least one power storage device 160, which may be connected by wiring 165 to the wind turbine, solar array and/or illumination device 125. The controller may control power flow carried by the wiring 165. The interconnectivity of the at least one power storage device 160, electronics 157, wind turbine 110, solar array and illumination device 125 may comprise a plurality of circuits and cables to provide optimum protection of the power storage device (to prevent overcharging for example), wind turbine 110 and solar array 130, while permitting easy access at ground level by maintenance personnel.

The electronics 157 may also include, at least in part, a detector (not shown) for detecting ambient light levels for detecting when to supply power to the illumination device 125 or when to turn power off (such as during daylight). Such a detector may comprise a photo detector that in some embodiments may be mounted to the support structure 116 for providing detection of ambient light levels.

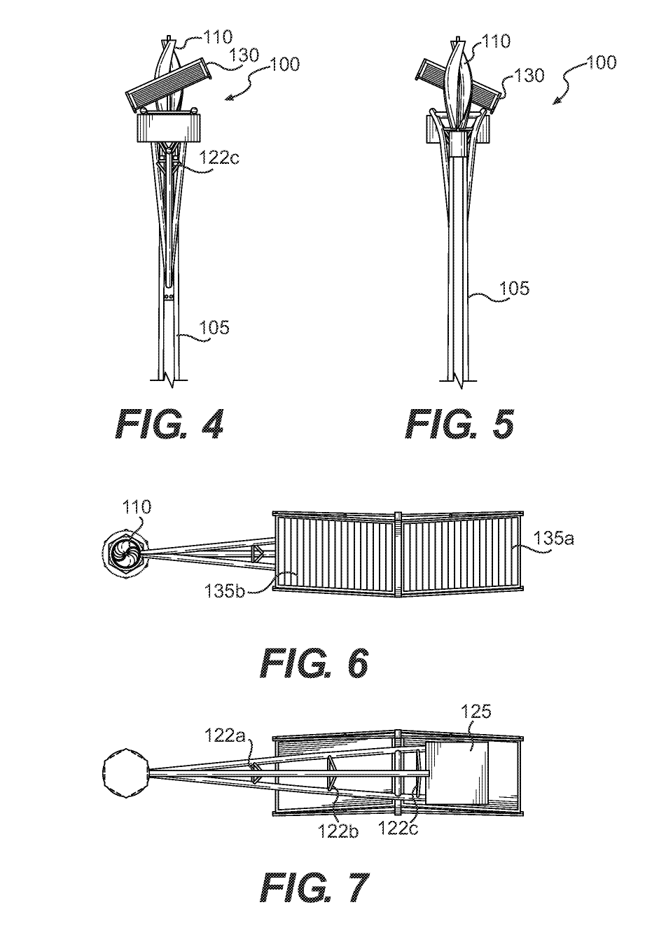

FIG. 2 is a side elevation view of the apparatus of FIG. 1A. FIG. 3 is an opposite side elevation view of the apparatus of FIG. 1A. FIG. 4 is a front elevation view of the apparatus of FIG. 1A; FIG. 5 is a rear elevation view of the apparatus of FIG. 1A. FIG. 6 is a top plan view of the apparatus of FIG. 1A; and FIG. 7 is a bottom plan view of the apparatus of FIG. 1A, and shows the exemplary bracing members 122a, 122b, and 122c somewhat more clearly.

The combined wind and solar powered light apparatus 100 may be considered generally esthetically pleasing and may provide cost efficient light generation capability that may promote renewable energy principles and does not require usual trenching of power lines as would be found in traditional commercially powered street lights and the like. The combined wind and solar powered light apparatus 100 also provides for illumination, even if commercial power is disabled or not available, because it does not rely upon such commercial sources of power; hence is immune from commercial power outages. Instead, the combined wind turbine and solar array technique described herein provides for stable and storable power by way of a power storage medium such as a battery for providing renewable energy to generated light when activated, such as by a light level detector (e.g., photo detector), or other turn on/off mechanism. The wind turbine is typically constructed to generate storable power at wind speeds ranging from, for example, but not limited to, about 3 mph to about 165 mph.

The solar array 130 may vary in size, but typically provides a large portion of the storable power during sunlight periods. The output of the solar array 130 may vary depending on geographic installation and amount of sunlight, but on average for typical installations, it provides a substantial amount of overall storable power. Combined, the solar array 130 and wind turbine 110 may provide power via the power storage device 160 permitting the illumination device 125 to function for one or several nights in most applications, likely even during an extended cloudy period and low wind periods, as well as provide power to the accessories affixed to the combined wind and solar powered light apparatus 100. Moreover, in some embodiments, the electronics may include a controller, and the electronics may be configured to turn the illumination device 125 on or off at select portions of the night and/or based on motion detection, if illumination is not required all night, or to conserve power. The illumination device 125 may be powered by power provided both the wind turbine 110 and the solar array 130. The power storage device 160 may receive power from both the wind turbine 110 and the solar array 130 during their respective active production periods for redistribution to the illumination device 125. In some embodiments, the illumination device 125 may be controlled such that the illumination device 125 provides reduced amounts of illumination based on available power. This may be accomplished by turning off one or more portions of the illumination device 125, for example.

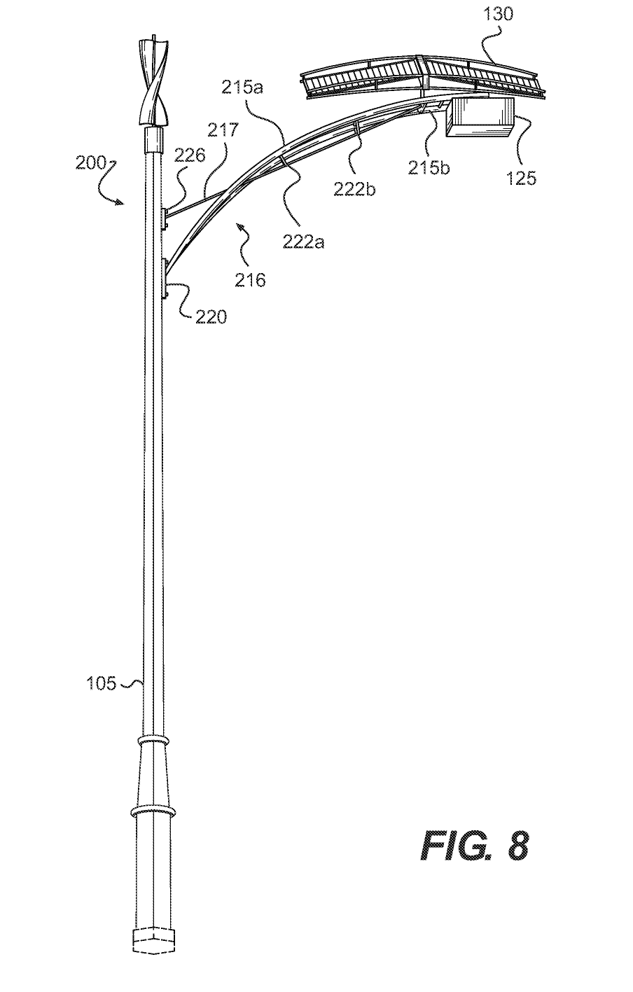

FIG. 8 is bottom perspective view of an embodiment of a combined wind and solar powered light apparatus, constructed according to principles of the invention, generally denoted by reference numeral 200. A horizontal support structure 216 may be configured with a plurality of first curved support arms 215a, 215b that may be configured to extend from a common mounting mechanism 220. The mounting mechanism 220 may be configured to be secured to a vertical support structure 105. A second support arm 217 may extend from a second mounting mechanism 226 to assist in supporting the solar panel 130 and/or illumination device 125. Bracing members 222a, 222b may be configured to brace the second support arm 217 with the first curved support arms 215a, 215b. The solar panel 130 and/or illumination device 125 may have a common height above ground with the wind turbine. Moreover, the first curved support arms may have first ends proximate the vertical support structure 105 and second ends proximate the solar panel and/or illumination device. The second ends may be at substantially a common height above ground with the wind turbine. A common height may be measured from a common point at ground level.

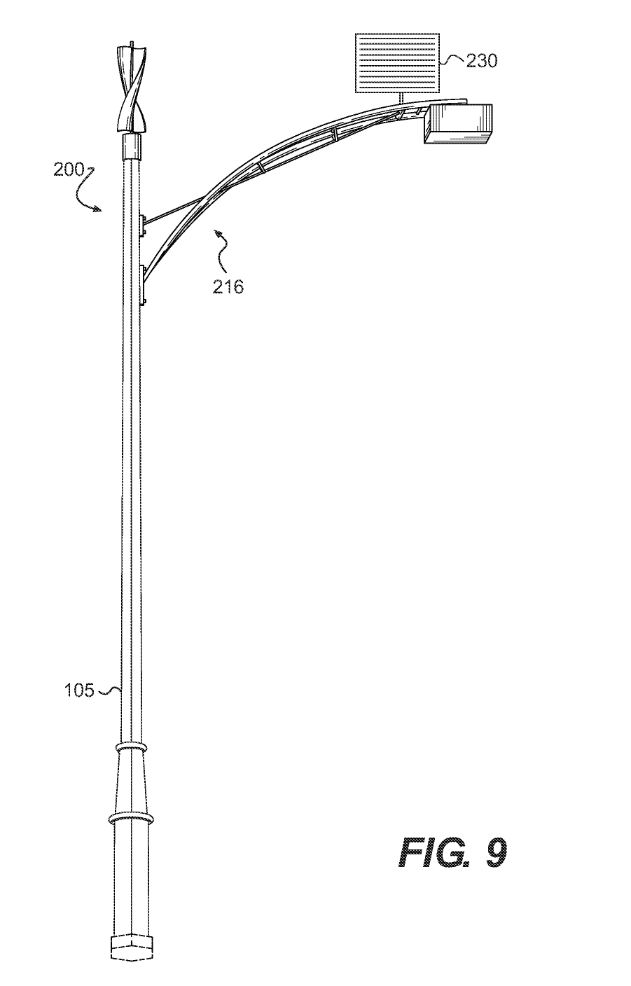

FIG. 9 is bottom perspective view of an embodiment of a combined wind and solar powered light apparatus 200 of FIG. 8, except showing a single solar panel, constructed according to principles of the invention. The single solar panel 230 may be configured to be mounted to the horizontal support structure 216, as shown. The single solar panel 230 may be employed in the embodiment of FIG. 1 as an alternative to the solar array 130.

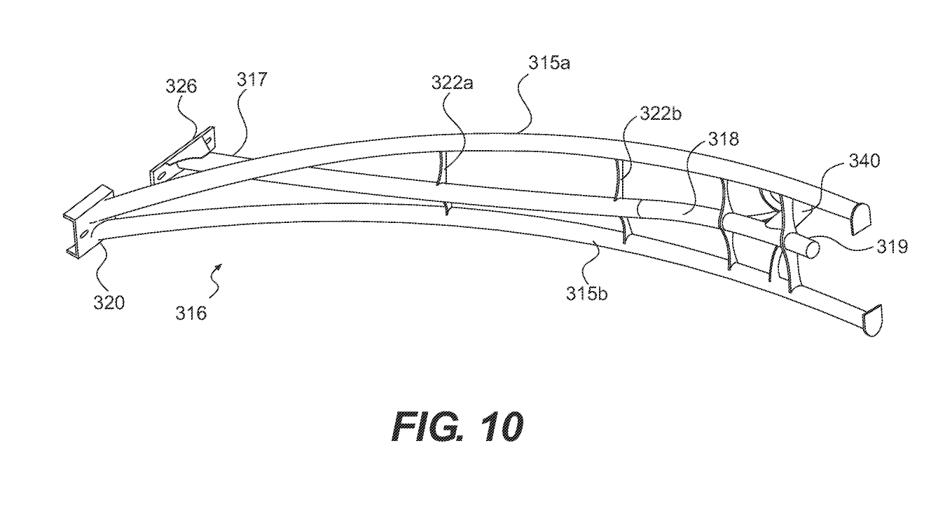

FIG. 10 is a perspective view of an embodiment of a horizontal support structure, constructed according to principles of the invention. The horizontal support structure 316 may be utilized as an alternative to the horizontal support structure including the second support arm of FIGS. 1, 8 and 9, and may be configured to be secured to a vertical support structure 105. The horizontal support arm 316 may be configured as a plurality of first curved support arms 315a, 315b extending from a common mounting mechanism 320. The shape and configuration of the mounting mechanism 320 and second mounting mechanism 326 are illustrative and may take on different characteristics as necessary for mounting to a vertical support structure. A second support arm 326 may be configured to extend from a second mounting mechanism 326 and may curve 318 with a distal end 319 proximate an attaching member 340 for supporting and/or connecting a solar array 130 or solar panel 230. The curve 318 may include a radius along substantially the entire extent of the second support arm 326, or may include a radius along a portion of the second support arm 326. The distal end 319 may also be proximate an illumination device such as 125, when present.

The combined wind and solar powered light apparatus 100, 200 when constructed according to principles of the invention may provide for a very cost efficient and durable light producing technique suitable for general deployment in most geographic locations at a significant cost savings when compared to conventional commercially power light solutions, such as street lights. One type of savings may include complete elimination of commercial power bills.

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

We claim:

1. An apparatus for producing and utilizing power for illumination, comprising:
a wind turbine configured to be mountable to a first support structure;
a second support structure configured to be connected to the first support structure;
a solar array configured to be connected to the second support structure; and
an illumination device mounted to the second support structure and powered by the wind turbine and the solar array.

2. The apparatus of claim 1, further comprising:
a power storage device configured to be connected to at least one of the wind turbine, the solar array and the illumination device.

3. The apparatus of claim 2, further comprising:
an electrical circuit configured to control power charging and discharging to and from the power storage device.

4. The apparatus of claim 1, further comprising the first support structure, wherein the first support structure comprises a street light post.

5. The apparatus of claim 2, wherein the first support structure includes an internal compartment for storing the power storage device.

6. The apparatus of claim 1, wherein the wind turbine includes a generator configured to be driven by blades of the wind turbine and configured to provide electrical power.

7. The apparatus of claim 1, wherein the second support structure comprises a plurality of arms extending from a common location, the arms configured to support the solar array and the illumination device.

8. The apparatus of claim 7, wherein at least a subset of the plurality of arms are curved and each of the subset of the plurality of arms having a first end and a second end, the first end proximate the first support structure, the second end proximate the illumination device, and the second end being at a common height as the wind turbine above ground.

9. The apparatus of claim 8, wherein the subset comprises at least two arms.

10. The apparatus of claim 1, wherein the illumination device comprises a light emitting diode (LED) array.

11. The apparatus of claim 1, wherein the wind turbine comprises a vertical pair of blades configured in a spiraled or curved fashion around a vertical axis.

12. The apparatus of claim 1, wherein the solar array comprises a plurality of solar cells.

13. The apparatus of claim 1, further comprising:
a power storage device configured to store power; and
wiring connecting the wind turbine to the power storage device,
wherein the wiring is configured to carry power from the solar panel to the power storage device, and
wherein the wiring is further configured to carry power from the power storage device to the illumination device.

14. The apparatus of claim 12, further comprising a controller to control power flow carried by the wiring.

15. An apparatus for producing and utilizing power for illumination, comprising:
a vertical support structure;
a wind turbine mounted to one end of the vertical support structure and configured to produce electrical power from wind energy;
a second support structure connected to the vertical support structure, the second support structure curving away from the vertical support structure;
a solar panel mounted to the second support structure and configured to provide electrical power; and
an illumination device mounted to the second support structure and powered by the solar panel and the wind turbine,
wherein the wind turbine is configured to rotate about a vertical axis, and
wherein the vertical support structure has a longitudinal axis that is substantially parallel with the vertical axis, and
wherein the solar panel and wind turbine have a common height above ground.

16. The apparatus of claim 15, wherein the second support structure is curved substantially along the entire extent of the second support structure.

17. The apparatus of claim 15, wherein the second support structure comprises a plurality of arms connected together proximate the vertical support structure and extending in a curved fashion to support the illumination device and the solar panel.

18. The apparatus of claim 17, further comprising a cross bracing that connects the plurality of arms together.

19. The apparatus of claim 15, further comprising a third support structure connected to the vertical support structure and configured to assist in supporting the solar panel and the illumination device.

20. The apparatus of claim 15, wherein the solar panel comprises a plurality of solar panels, each solar panel configured at a different angle from the other.

21. The apparatus of claim 15, wherein the wind turbine includes a set of blades oriented in a vertical manner and configured in a spiraled manner around a vertical axis, the apparatus further comprising:
a power storage device chargeable by power received from the solar panel or the turbine, the power storage device configured to power the illumination device.

22. A method for producing and utilizing power for electrical devices, comprising the steps of:
providing a wind turbine having blades oriented in a curved fashion about a vertical axis, the wind turbine configured to produce electrical power from wind energy;
providing a solar array to produce electrical power from sunlight;
providing a light emitting diode (LED) illumination device configured to be powered by both the electrical power produced from the wind energy and electrical power produced from the sunlight; and
mounting the wind turbine and solar array to different portions of a common support structure, and mounting the LED illumination device to one of the different portions,
wherein the wind turbine and solar array have a substantially common height above ground.

23. The method of claim 22, wherein the step of providing a wind turbine provides a wind turbine having a single pair of blades.

24. The method of claim 22, wherein the LED illumination device has a common height above ground with the wind turbine.

25. The method of claim 22, wherein the step of mounting mounts the solar panel and the illumination device to a same different portion, the same different portion having a curved horizontal extent.
